(19) United States
(12) Patent Application Publication
(10) Pub. No.: US 2022/0111547 A1
(43) Pub. Date: Apr. 14, 2022

(54) Rotary Die Axis Synchronization System and Adjustable Wedge Apparatus Therefor

(71) Applicant: Bernal, LLC, Rochester HIlls, MI (US)

(72) Inventor: Richard Earl Groulx, Corunna, MI (US)

(73) Assignee: Bernal, LLC, Rochester Hills, MI (US)

(21) Appl. No.: 17/069,091

(22) Filed: Oct. 13, 2020

(51) Int. Cl. B26D 7/26; B26D 7/20

(52) U.S. Cl. CPC B26D 7/2635; B26D 7/20

(57) ABSTRACT

An adjustable wedge apparatus is provided that includes a split wedge, a first block, a second block, a threaded adjustment screw, and an expandable and contractable biasing device. The split wedge is configured to be sandwiched between the first block and the second block. The first block and the second block are configured to be held together, with the split wedge between, by the expandable and contractable biasing device. The spilt wedge has a narrow end divided into two tines, and a threaded through-hole. The threaded adjustment screw has an external thread that is complementary to the internal thread of the through-hole. Tightening the threaded adjustment screw spreads apart the first block and the second block. An axle alignment system including the adjustable wedge apparatus is also provided, for example, a rotary die cutter alignment system. A method skew of adjustment is also provided.

### FIELD OF THE INVENTION

The present invention relates to systems and processes for mounting and positioning rotating rolls in a rotary die. More specifically, the present invention relates to a roll mounting and positioning system.

### BACKGROUND OF THE INVENTION

Rotary die cutters are well known for cutting apertures of various sizes and shapes in a running web, particularly a web operating in conjunction with a printing press. An exemplary application of such die cutters is to cut peel-off labels carried on a backing sheet. Known rotary die cutters utilize a pair of rolls rotating about two parallel axes that are rotatably mounted between a pair of side frames. The rolls are driven by a line shaft. One roll, designated as the die roll, or cylinder, carries flexible sheet metal dies on its outer surface, which include cutting and creasing lands. Each die is formed from a thin metal sheet and has raised lands formed in the shape of an aperture to be cut and crease lines to be formed. The die is wrapped around the die cylinder and secured to it, for example, by magnetic attraction produced by permanent magnets embedded in the die cylinder. Dies can also be secured by tapes, mechanical clamps, or other types of fasteners. The anvil cylinder is formed of a hardened material and is of such diameter that its surface speed is substantially equal to the web speed.

As the web passes between the rotating cylinders, the cutting and creasing lands of the die are pressed into the web backed up by the anvil cylinder to produce the desired aperture and creases in the web. Such rotary die cutters have end-mounted die rolls and anvil rolls, and side frames. Problems arise due to the deflection of the die roll caused by operating forces, machine distortions, vibrations, and thermal expansions. A traditional solution has been to utilize a roll having a sufficiently large diameter that it is able to resist any significant deflection. While this can work, the necessary roll diameter can be too large for many applications. Moreover, there is a disadvantage in that such a die cylinder can be large and costly to manufacture. This is particularly true where the outer surface of the die cylinder must be machined to extremely tight tolerances. In addition, the substantial rotational inertia of such a large diameter die roll is an impediment to achieving a fast stop in the case of an emergency stop.

Other disadvantages relate to the need to have the apertures extremely accurately located so that they are in registration with the pattern printed on a web. A vertical adjustment of the die, one affecting the spacing between the die and anvil rolls, is also important to adjust the spacing between the cutting and creasing lands of the die and the anvil cylinder. Axial adjustment is just as important so that the die achieves a reliable cut in the web, the cutting lands do not strike the anvil cylinder becoming dulled or damaged, and so that the correct spacing occurs across the full length of the die roll. In addition, as is well known to those skilled in the art, even when proper adjustments in the position of the dies are made, changes in factors such as the web material, wear of the die, and shifts in the relative position of components due to thermal expansion, can require periodic readjustments of the die positions in order to have reliable cuts and creases.

Another known technique for changing the axis to axis (vertical) spacing of the rolls is to mount at least one of the rolls on an eccentric so that its center line location can be varied between two extreme positions. Such adjustments cannot be made on the run, that is, while the rotary die is running, and a web or paperboard blanks are passed through the rotating die cutter cylinders. Axial and circumferential adjustments of the die also require that the rotary die be stopped while the die position is manually shifted on the die cylinder and reset. The adjustment process is manual, time-consuming, and cannot be made on the run. Also, eccentric adjustments do not provide the fine degree of adjustment often required to compensate for wear or the other factors listed above. When eccentrics have been used while the rotary die cutter is operating, they have been used most often to move the die roll a substantial distance to go “off impression”, that is, moving the die cylinder away from the web to allow operation but without operation of the die cutter.

Conventional rotary die cutters utilize only one die cylinder and the only practical way to adjust the axial or side to side position of a web is to shift the lateral position of the web as it passes through the cutter. This web shift has a significant disadvantage in that it requires that all of the other pieces of equipment in the line, such as gluers, perforators, numbering machines, plow stations, and combinations thereof also be adjusted with respect to the web to maintain registration. This multiple adjustment of a series of machines to the web shift is time-consuming and tedious. A need exists for a rotary die cutter capable of an axial adjustment of the cutter. A need also exists for an apparatus that enables a rotary die cutter to be axially adjustable, especially quickly and reliably.

### SUMMARY OF THE INVENTION

It is therefore an object of the present invention to provide a mounting and positioning system for a rotary die cutter.

It is another object of the present invention to provide a mounting and positioning system that provides extremely accurate positioning of the die with respect to a web and an anvil roll, including positioning vertically, axially, and circumferentially.

Yet another object of the present invention is to provide a rotary die cutter positioning and mounting system wherein adjustments can be made with extreme accuracy, independently of one another, and while the die cutter is operating.

It is yet another object of the present invention to provide a rotary die cutter mounting and positioning system that can be set up or adjusted within an extremely short make-ready time as compared to conventional systems currently in use.

Still another object of the present invention is to provide a mounting and positioning system for a rotary die cutter, which can mount two or more die rolls in an axially spaced relationship operating in cooperation with the same anvil where each die roll can be adjusted vertically and axially independently of the other yet exhibit all of the foregoing advantages.

Yet another object of the present invention is to provide a roll positioning and mounting system for a rotary die cutter that has a favorable cost of manufacture and that can be adapted to an existing system.

These and other objects and advantages of the present invention will become evident by the appended drawings and by the detailed description that follows, both of which are intended to illustrate, not limit, the present teachings.

### BRIEF DESCRIPTION OF THE DRAWINGS

The invention may be more fully understood with reference to the accompanying drawings. The drawings are intended to illustrate, not limit, the present teachings.

FIG. 1A is a perspective view of an adjustable wedge apparatus according to an embodiment of the present invention.

FIG. 1B is a top view of the adjustable wedge apparatus shown in FIG. 1A.

FIG. 1C is a front end view of the adjustable wedge apparatus shown in FIGS. 1A and 1B.

FIG. 1D is a right-side view of the adjustable wedge apparatus shown in FIG. 1A.

FIG. 1E is a top view of the adjustable wedge apparatus shown in FIG. 1A, with exemplary dimensions shown.

FIG. 1F is a right-side view of the adjustable wedge apparatus shown in FIG. 1A, with exemplary dimensions shown.

FIG. 1G is an end view of the adjustable wedge apparatus shown in FIGS. 1A and 1B, with exemplary dimensions shown.

FIG. 2A is a perspective view of a split wedge according to an embodiment of the present invention.

FIG. 2B is a top view of the split wedge shown in FIG. 2A.

FIG. 2C is a right-side view of the split wedge shown in FIG. 2A.

FIG. 2D is an end view of the split wedge shown in FIGS. 2A and 2B.

FIG. 2E is a top view of the split wedge shown in FIG. 2A, with exemplary dimensions shown.

FIG. 2F is a right-side view of the split wedge shown in FIG. 2A, with exemplary dimensions shown.

FIG. 2G is an end view of the split wedge shown in FIGS. 2A and 2B, with exemplary dimensions shown.

FIG. 3A is a perspective view of a first block or second block according to an embodiment of the present invention.

FIG. 3B is a top view of the first block or second block shown in FIG. 3A.

FIG. 3C is an inside, side view of the first block or second block shown in FIG. 3A.

FIG. 3D is an end view of the blunt end of the first block or second block shown in FIGS. 3A and 3B.

FIG. 3E is a top view of the first block or second block shown in FIG. 3A, with exemplary dimensions shown.

FIG. 3F is an inside, side view of the first block or second block shown in FIG. 3A, with exemplary dimensions shown.

FIG. 3G is an end view of the first block or second block shown in FIGS. 3A and 3B, with exemplary dimensions shown.

FIGS. 4A-4C illustrate relative axial orientations wherein a skew adjustment is to be made in accordance with an embodiment of the present invention, to axially align upper and lower rotary tools.

FIGS. 5A-5C illustrates an adjustment method to correct skew in accordance with an embodiment of the present invention.

FIG. 6A is an end view of a rotary tool including a skew adjustment system according to an embodiment of the present invention.

FIG. 6B is an enlarged view of section 6B shown in FIG. 6A.

### DETAILED DESCRIPTION OF THE INVENTION

The present invention provides an adjustable wedge apparatus that can be tightened or loosened to increase or decrease the spacing it provides and adjust skew in a rotary die cutter. The adjustable wedge apparatus comprises a split wedge, a first block, a second block, a threaded adjustment screw, and an expandable and contractable biasing device. The split wedge is configured to be sandwiched between the first block and the second block. The first block and the second block are configured to be held together, with the split wedge there between, by the expandable and contractable biasing device. The threaded adjustment screw can be rotated to expand or contract the spread provided between the first block and the second block.

The split wedge has a blunt end, a narrow end, a recess, a through-hole, and a pair of through-slots. The recess has an opening at the narrow end, which extends toward the blunt end. The recess also has a recess bottom. The recess divides the narrow end into two tines, namely, an upper tine and a lower tine. The through-hole extends from the blunt end to the bottom of the recess and has an internal thread. The pair of through-slots at least partially straddle the recess and respectively extend along the tines.

The threaded adjustment screw has an external thread that is complementary to the internal thread of the through-hole. Each of the first block and the second block has a pair of projections configured to align respectively with the pair of through-slots, for catching the biasing device. The projections of each block can be formed by a split pin forced through the block in a height direction. Each through-slot of the pair of through-slots, and the biasing device, are configured such that the biasing device can pass through the through-slots and catch one of the projections of the first block and one of the projections of the second block.

Although the components can be packaged, disassembled, or packaged separately, the present invention also provides an assembled apparatus. The adjustable wedge apparatus can be assembled together such that the split wedge is sandwiched between the first block and the second block. When the adjustable wedge apparatus is assembled, the biasing device can be caught on a first projection of the first block and caught on a first projection of the second block. The biasing device can pass through a first through-slot of the pair of through-slots and can bias the first block and the second block such that they are urged toward one another. When the adjustable wedge apparatus is assembled, the threaded adjustment screw bears against the first block and the second block, extends through the recess, and is threaded into the through-hole.

The assembled adjustable wedge apparatus can further include a washer. The threaded adjustment screw can have a head and the washer can be positioned between the head and both the first block and the second block such that one side of the washer contacts the head and the other side of the washer contacts both the first block and the second block. When the adjustable wedge apparatus is assembled together, the projections of the first block have respective distal ends that are separated from one another in a height direction, by a first distance. The through-slots of the spilt wedge can be separated by a maximum spacing and the first distance can be greater than the maximum spacing.

The biasing device can comprise a flat, metal, split, planar ring that can expand and contract within a plane. The split ring can be rigid with respect to deforming out of the plane. The biasing device can comprise a spring steel material. The biasing device can comprise an internal retaining ring having internally protruding inner ring features on which the projections of the first block and the second block can catch. The biasing device can comprise a pair of biasing devices, for example, the biasing device can comprise a pair of retaining rings. An exemplary biasing device is a spring steel, internal retaining ring for bores, available as item number 38DN71 from Grainger Industrial Supply of Lake Forest, Ill.

The adjustable wedge apparatus can further comprise a mounting bracket in contact with, or integrally formed as part of, at least one of the first block and the second block. The mounting bracket can have a through-hole formed therethrough, through which a fastener can partially pass to mount the mounting bracket to a surface, for example, to a surface of a rotary tool bearing housing. The mounting bracket through hole can be threaded or can have an inner diameter that is larger than the outer diameter of a bolt or other fastener intended to pass through the through-hole. The mounting bracket can be formed integral with the first block, for example, part of the first block such that the mounting bracket and first block together form a solid monolithic structure. The mounting bracket can be made as a separate component, that is, not integral with either the first block or the second block. As a separate component, the mounting bracket can swing to the left side of the adjustable wedge apparatus, to the right side of the adjustable wedge apparatus, to the top of the adjustable wedge apparatus, to the bottom of the adjustable wedge apparatus, or to an angle with respect to the adjustable wedge apparatus.

The pair of projections on the first block can comprise opposite ends of a slotted spring pin extending through a first block through-hole. The block through-hole can be formed through the first block in a height direction. The pair of projections on the second block can comprise opposite ends of a second slotted spring pin extending through a second block through-hole. The second block through-hole can be formed through the second block in a height direction.

The first block can have a top surface, an opposite bottom surface, and an inner side surface configured to contact the spilt wedge. Each of the top surface and the bottom surface can have a block recess formed therein. The pair of projections of the first block can protrude from the top surface block recess and from the bottom surface block recess. The second block can also have a top surface, an opposite bottom surface, and an inner side surface configured to contact the spilt wedge. Each of the top surface and the bottom surface of the second block can have a block recess formed therein. The pair of projections of the second block can protrude from the top surface block recess of the second block and from the bottom surface block recess of the second block.

According to various embodiments of the present invention, an axis alignment or synchronization system is provided. The system can comprise an axle configured for rotation around an axis of rotation. An assembled adjustable wedge apparatus as described herein, or a pair or other set of such adjustable wedge apparatuses, can be positioned in contact with the axle or in contact with a first axle bearing housing. The first axle bearing housing can be configured to hold a first end of the axle for rotation of the axle. The axle can have a second end, opposite the first end. The system can include a second bearing housing that is also configured to enable rotation of the axle, and the second end of the axle can be housed in the second bearing housing. An assembled adjustable wedge apparatus as described herein, or a pair or other set of such adjustable wedge apparatuses, can be positioned in contact with the axle or in contact with a first axle bearing housing. Adjusting the assembled adjustable wedge apparatus or apparatuses by turning the respective threaded adjustment screw can enable an adjustment of the position of the axis of rotation. In an exemplary embodiment, four adjustable wedge apparatuses of the present invention are used at each end of the system to adjust the respective bearing housing at the respective end of the axle. The axle adjustment system can be used in a rotary die tool according to various embodiments of the present invention.

The present invention also provides a method of adjusting an axis of rotation of an axle. The method can comprise providing an axle alignment system as described herein and turning the threaded adjustment screw to change a position of the axis of rotation. The method is particularly useful in aligning an upper cutting cylinder of a rotary tool with a lower anvil cylinder of the rotary tool as will be even more apparent from the description that follows.

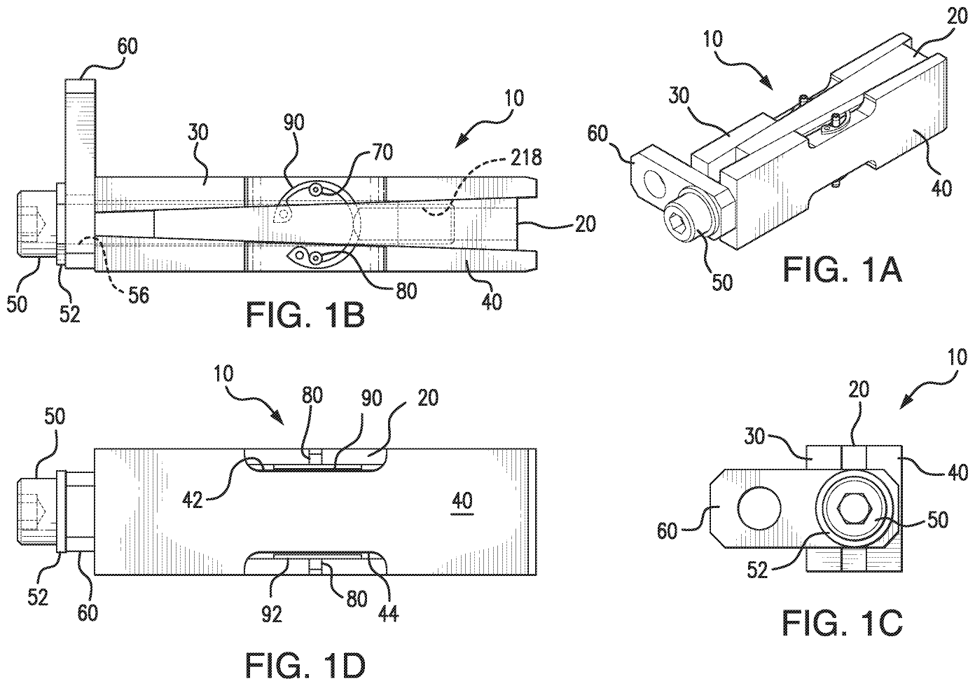

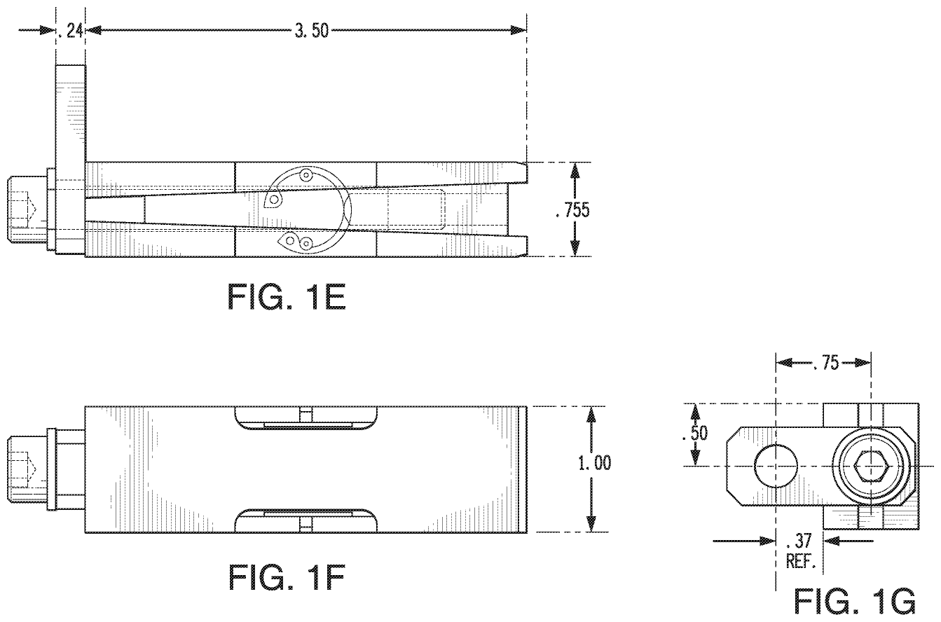

With reference now to the drawings, FIGS. 1A-1G show an adjustable wedge apparatus 10 according to an exemplary embodiment of the present invention. FIG. 1A is a top, right, front perspective view, FIG. 1B is a top view, FIG. 1C is a front end view and FIG. 1D is a right-side view of adjustable wedge apparatus 10. FIGS. 1E-1G correspond to FIGS. 1B-1D, respectively, and show exemplary dimensions that can be used for forming adjustable wedge apparatus 10 and its individual components. As can be seen, FIGS. 1A-1G show that adjustable wedge apparatus 10 comprises a split wedge 20, a first block 30, a second block 40, a threaded adjustment screw 50, and two expandable and contractable biasing devices 90 and 92. Split wedge 20 is configured to be sandwiched between first block 30 and second block 40. First block 30 and second block 40 are configured to be held together, with split wedge 20 there between, by expandable and contractable biasing devices 90 and 92.

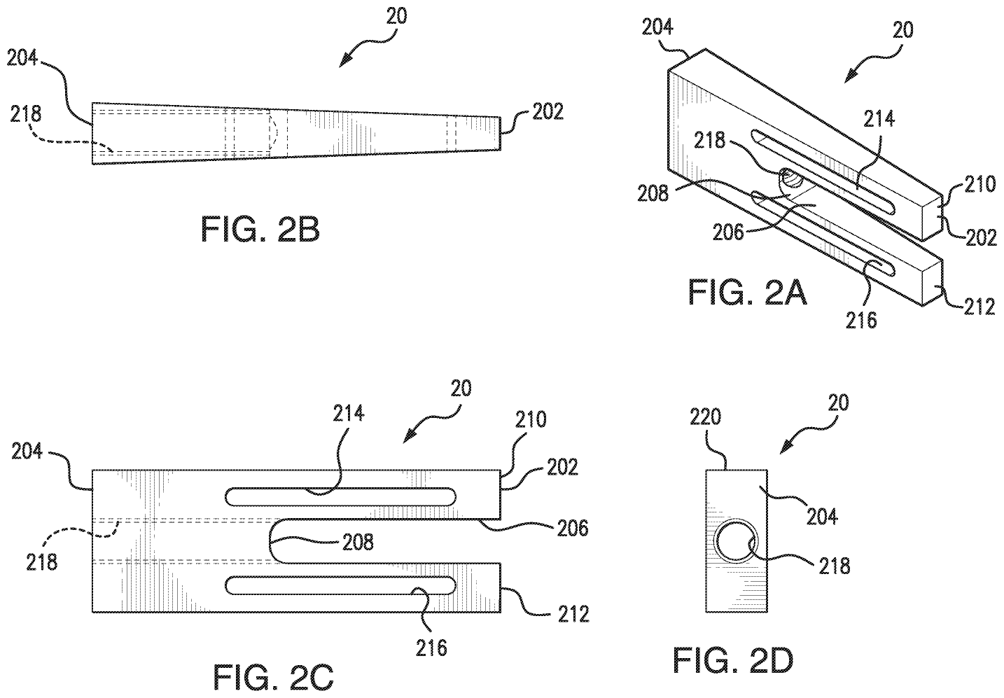

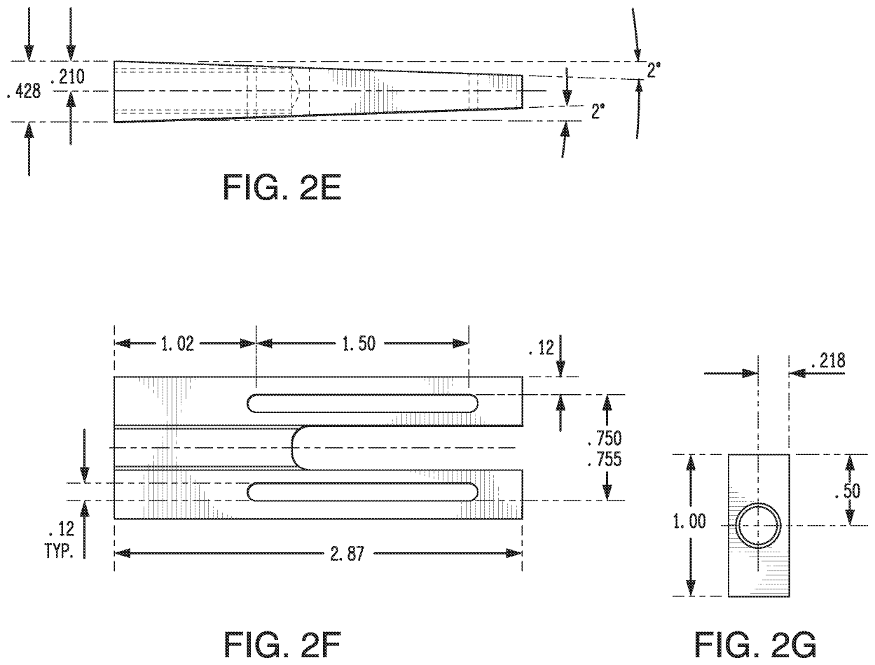

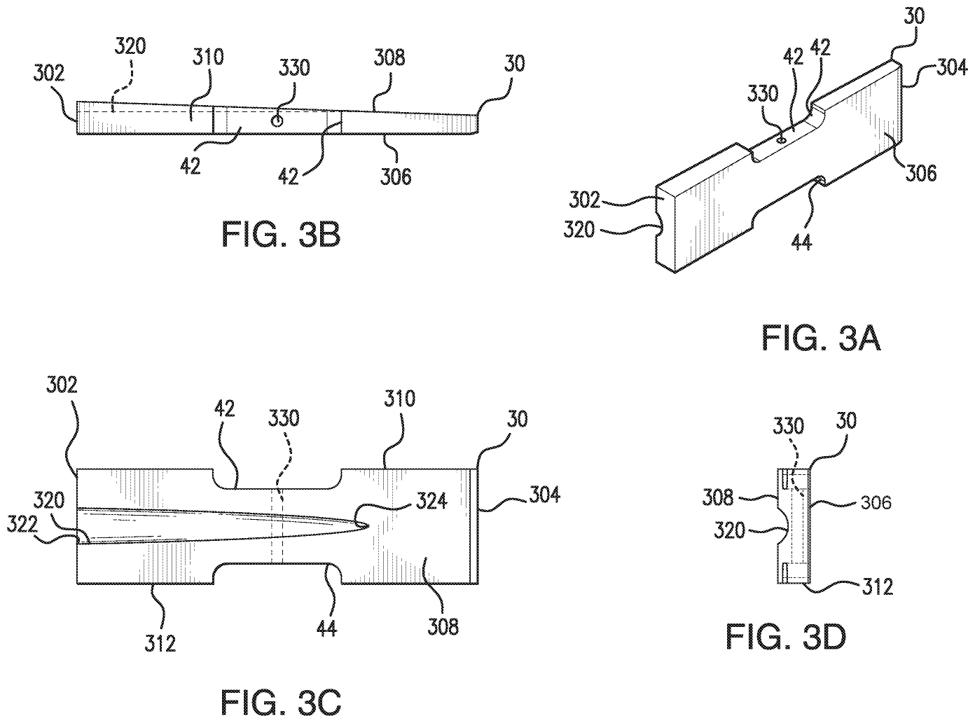

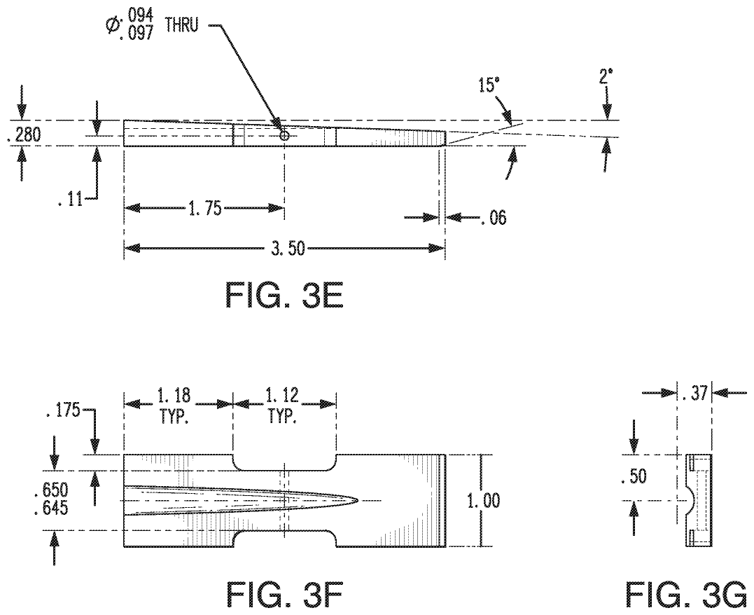

As best seen in FIG. 1D, second block 40 has a split pin 80 extending therethrough, through a through-hole. A through-hole for this purpose can be seen in FIG. 3C as through-hole 330. Split pin 80 projects from second block 40 in a recess 42 at the top of second block 40. Split pin 80 also projects from second block 40 in a recess 44 at the bottom of second block 40. As such, split pin 80 forms a pair of projections configured to align respectively with a pair of through-slots in split wedge 20, as shown in FIGS. 2A, 2C, and 2F that are described in greater detail below. In the embodiment shown, first block 30 is identical to second block 40 and each is exemplified by block 30 shown in FIGS. 3A-3G. Accordingly, split pin 70 extends through a through-hole in first block 30, projects from first block 30 in a recess 42 at the top of first block 30, and also projects from first block 30 in a recess 44 at the bottom of first block 30. As such, split pin 70 forms a pair of projections configured to align respectively with the through-slots in split wedge 20.

FIGS. 1B and 1E also shows a biasing device 90 in the form of a first, flat, metal, internal retaining ring. Biasing device 90 is captured on the top projections of split pins 70 and 80, biasing first block 30 and second block 40 toward each other. A second biasing device 92, also in the form of a flat, metal, internal retaining ring, is shown in FIGS. 1D and 1G captured on the bottom projections of split pins 70 and 80. Biasing device 92 also biases first block 30 and second block 40 toward each other. Each of biasing devices 90 and 92 can comprise a flat, metal, split, planar ring that can expand and contract within a plane but that is rigid with respect to deforming out of the plane. Each biasing device 90 and 92 can comprise a spring steel material. Biasing devices 90 and 92 can be internal retaining rings for bores and can have interiorly protruding catch holes.

As seen in FIGS. 1A and 1D, the projections formed by split pin 80 have respective distal ends and the distal ends are separated in a height direction by a first distance. Through-slots 214 and 216 of spilt wedge 20 are separated by a maximum spacing, and, as can be seen, the first distance between the distal ends of the split pin is greater than the maximum spacing separating the through-slots. As such, once the biasing devices are caught on the split pin projections, they are captured in place.

Also shown in FIGS. 1A-1G is a bracket 60 for mounting adjustable wedge apparatus 10 to a bearing housing or other frame or housing, and bracket 60 has a through-hole 62 for such purpose. Bracket 60 is connected to the remainder of adjustable wedge apparatus 10 via threaded adjustment screw 50 passing through another through-hole 56 formed in bracket 60. A washer 52 is provided so that threaded adjustment screw 50 can rotate in a threaded through-hole 218 formed in split wedge 20, without becoming hung-up on bracket 60. Although bracket 60 is depicted as separate component, it is to be understood that, in place of bracket 60, a mounting bracket can be formed integral with at least one of the first block and the second block and can have a through-hole formed therethrough, through which a fastener can pass to mount the mounting bracket to a surface.

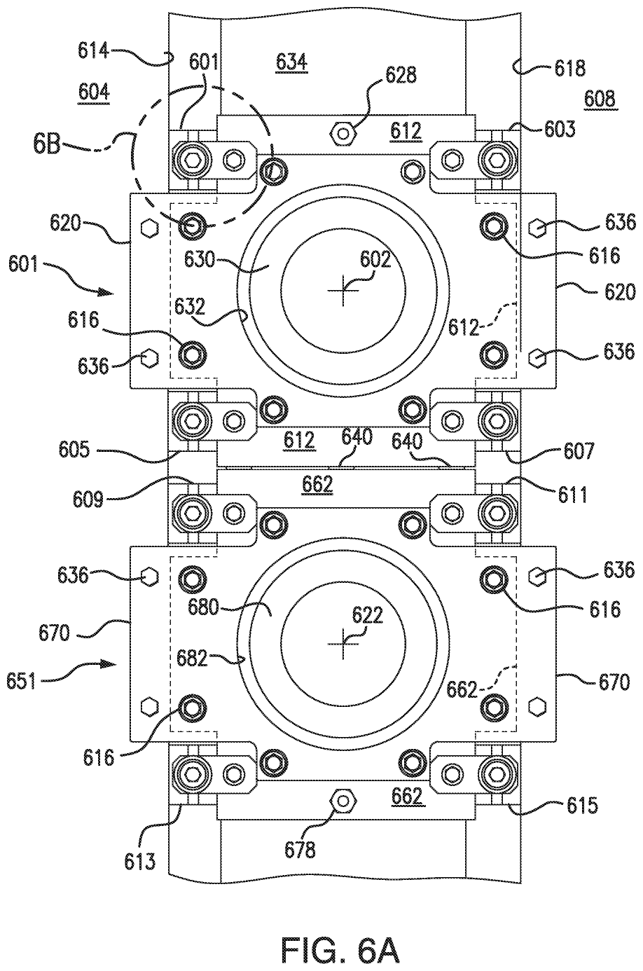

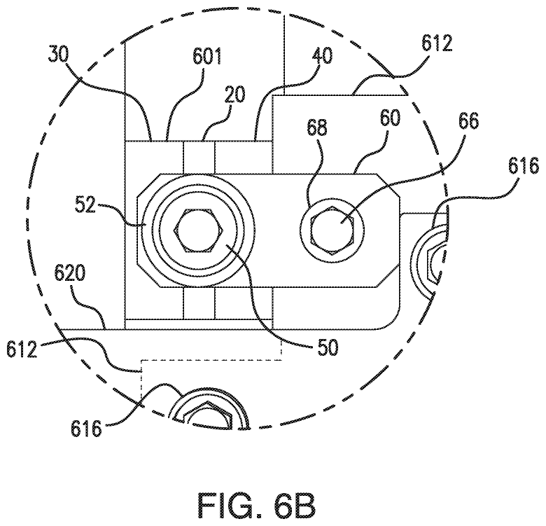

With the arrangement exemplified in FIGS. 1A-1G, threaded adjustment screw 50 can be tightened to spread apart first block 30 and second block 40 as split wedge 20 is moved closer and closer to bracket 60 and toward the head of threaded adjustment screw 50. While first block 30 and second block 40 are spread apart, the outer surfaces (306 in FIGS. 3A-3D) of first block 30 and second block 40 remain parallel to one another due to the wedge shape of split wedge 20 and the less-pronounced wedge shape of each of first block 30 and second block 40. With such an arrangement, the opposing, parallel, flat surfaces of adjustable wedge apparatus 10 can provide uniform pressure across a large area to secure, for example, a bearing housing within a frame as depicted in FIGS. 6A and 6B described below.

Although the adjustable wedge apparatus 10 is shown assembled in FIGS. 1A-1G, it is to be understood that the individual components of adjustable wedge apparatus 10 can be packaged and sold separately, or packaging, unassembled, as a kit.

With particular reference to FIGS. 2A-2G, split wedge 20 has a narrow end 202, a blunt end 204, a recess 206, a through-hole 218, and a pair of through-slots 214 and 216. Recess 206 has an opening at narrow end 202 and extends toward blunt end 204. Recess 206 has a recess bottom 208 and divides narrow end 202 into two tines 210 and 212. Through-slots 214 and 216 at least partially straddle recess 206 and respectively extend along tines 210 and 212. In the embodiment shown, split wedge 20 is symmetrically shaped from top to bottom and from side to side such that it could be turned upside down and still look the same. In the views shown, split wedge 20 has a top surface 220. Through-hole 218 extends from blunt end 204 to recess bottom 208 and has an internal thread. Threaded adjustment screw 50 (FIGS. 1A-1G) has an external thread that is complementary to the internal thread of the through-hole 218.

Through-slot 214, and the ring-shaped biasing device 90 (FIGS. 1B and 1D), are configured such that top biasing device 90 can pass through through-slot 214 and catch the top projections of split pins 70 and 80. Similarly, through-slot 216, and biasing device 92 (FIG. 1D), are configured such that biasing device 92 can pass through through-slot 216 and catch the bottom projections of split pins 70 and 80. Exemplary dimensions for split wedge 20 are shown in FIGS. 2E-2G.

As mentioned above, first block 30 and second block 40 are identical. As such, the features of each are described with reference to just first block 30. Exemplary dimensions for first block 30 and for second block 40 are shown in FIGS. 3E-3G.

With particular reference to FIGS. 3A-3G, first block 30 has a blunt end 302, a chamfered, narrow end 304, an outer surface 306, an inner surface 308, a top 310, a bottom 312, a top recess 42, and a bottom recess 44. In addition, a conical recess 320 is formed recessed into inner surface 308. Conical recess 320 has a wide end 322 that intersects with blunt end 302 of first block 30, and a narrow end 324 that terminates at inner surface 308. Conical recess 320 is provided along inner surface 308 to accommodate threaded adjustment screw 50 as threaded adjustment screw 50 passes between first block 30 and second block 40 and engages with threaded through-hole 218 of split wedge 20 to form the assembly shown in FIGS. 1A-1G. Like first block 30, second block 40 has a conical recess along its inner surface to likewise accommodate threaded adjustment screw 50 as threaded adjustment screw 50 passes between first block 30 and second block 40 and engages with threaded through-hole 218 of split wedge 20.

As mentioned above, through-hole 330 through first block 30 is provided to accommodate split pin 70 (FIGS. 1A, 1B, and 1D). Through-hole 330 begins at top recess 42, extends completely through first block 30, and terminates at bottom recess 44. Similarly, second block 40 has a through-hole identical to through-hole 330 shown in FIGS. 3A-3D but for accommodating split pin 80 shown in FIGS. 1A and 1B.

The adjustable wedge apparatus shown in FIGS. 1A-3G can be used to make skew adjustments in a rotary die tool. Initially, skew adjustments related to the axial parallelism between an upper cylinder and a lower cylinder can be factory set. Additional skew adjustments are sometimes required, however, to make the blades of an upper cylinder parallel to the blades of a lower cylinder such that the cut is uniform across the entire tool surface. Thermal expansion and contraction, vibrations over time, and wear can all contribute to the need for additional skew adjustment. According to various embodiments of the present invention wherein one or both of the rotary tools are heated, thermal expansion can noticeably affect skew. When the cutting is skewed, a skew adjustment is required.

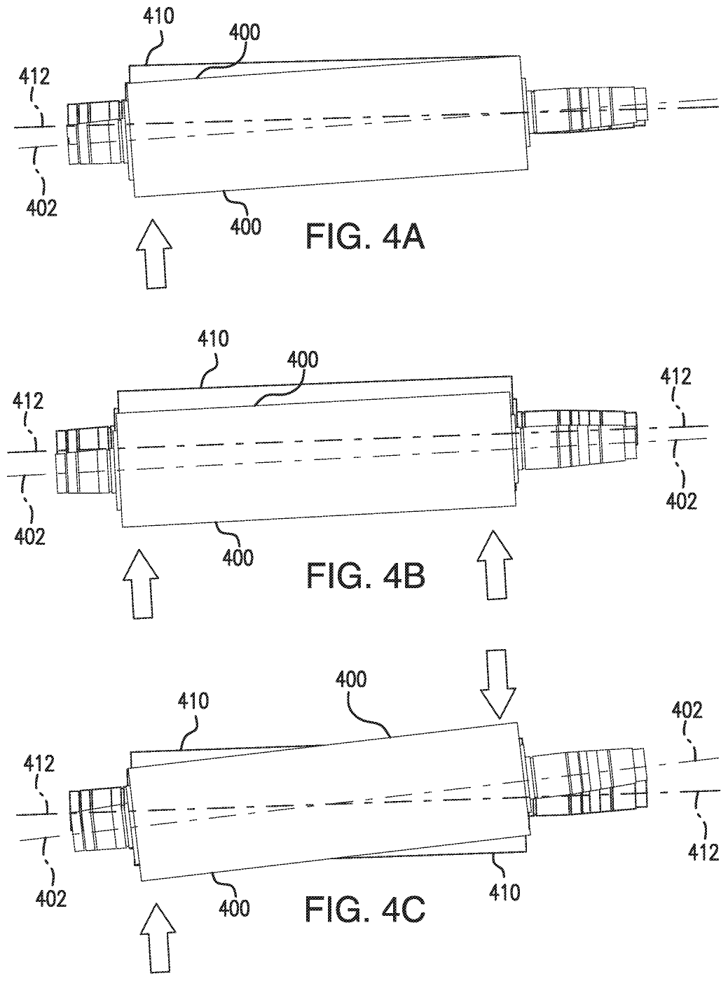

Skew is the degree of straightness or parallelism between the upper and lower cylinders, i.e., between the axes of the rotary tools. To test check for a skew, an imaginary line can be drawn through the center of each of the rotary tools, axially. Looking at the two center lines or axes from above, a skew can be determined by determining the parallelism of the lines relative to each other in a horizontal plane. Skew is not the variation up and down, of the lines as this instead is known as the gap. Examples of when a skew adjustment is needed are illustrated in the top views shown in FIGS. 4A-4C. In FIG. 4A, an upper cylinder 400 is shown skewed at its left end with respect to a lower cylinder 410. As can be seen, axis of rotation 402 of upper cylinder 400 is not lined-up with, or on the same horizontal plane as, axis of rotation 412 of lower cylinder 410. To align axes of rotation 402 and 412 of cylinders 400 and 410, respectively, a skew adjustment can be made to one or both of the bearing units holding upper cylinder 400. Adjustment to such a bearing unit would translate into an adjustment of axis of rotation 402. The adjustment can be made in the direction shown by the directional arrow. Lower cylinder 410 can remain locked in place.

In the situation shown in FIG. 4B, axis 402 of upper cylinder 400 is skewed at both ends of upper cylinder 400, with respect to axis 412 of lower cylinder 410. To align axis 402 with axis 412, adjustments can be made to both ends of upper cylinder 400, that is, to the position of both the left and right bearing units holding upper cylinder 400. The adjustment can be made at the two ends in the respective directions shown by the directional arrows. Meanwhile, lower cylinder 410 can remain locked in place.

In the situation shown in FIG. 4C, axis 402 of upper cylinder 400 is skewed in a first direction, at the left end of the cylinder, and in a second, opposite direction at the right end of the cylinder. The skew is with respect to axis of rotation 412 of lower cylinder 410. As such, an adjustment can be made to the bearing unit holding the left end of upper cylinder 400 in the direction shown by the directional arrow shown adjacent to the left end. An adjustment can also be made to the bearing unit holding the right end of upper cylinder 400 but in the opposite direction as shown by the directional arrow adjacent to the right end. Again, lower cylinder 410 can remain locked in place.

It is also within the realm of the present invention to instead adjust, or additionally adjust, one or both ends of lower cylinder 410.

Skew adjustment is important so that the dies properly cut and form material passing between the two cylinders, whether the material is a web or sheet. The web or sheet should be uniformly cut or formed across the tools. The following skew adjustment steps can be used to orient the rotary tools so that the center lines of the tools are directly in line with each other along a horizontal plane, i.e., so that the axes are aligned along the same horizontal plane.

First, a pair of cross-web cutting or creasing blades are located at each side of the rotary tools. Strips of paper 1 inch wide by 3 inches long, for example, can be cut and taped to the upper tool. One strip can be placed on each of the ends of the upper tool.

Second, the upper tool can be retreated until the tools stop cutting. This can be done by using a phase hub on the gear side of the upper tool.

Third, using a dial indicator, the upper tool can be advanced in 0.001-inch increments until the tools just starts to cut. Skew is considered adjusted if both ends of the tools start cutting at the same time. If the blade on one end begins to cut first, the tools are out of skew.

Fourth, the upper tool can continue to be advanced in 0.001-inch increments until the blade that was not cutting begins to cut or crease the paper.

Fifth, to determine the skew, the difference between the dial indicator readings is determined. The resulting difference indicates the necessary skewing adjustment that is to be made.

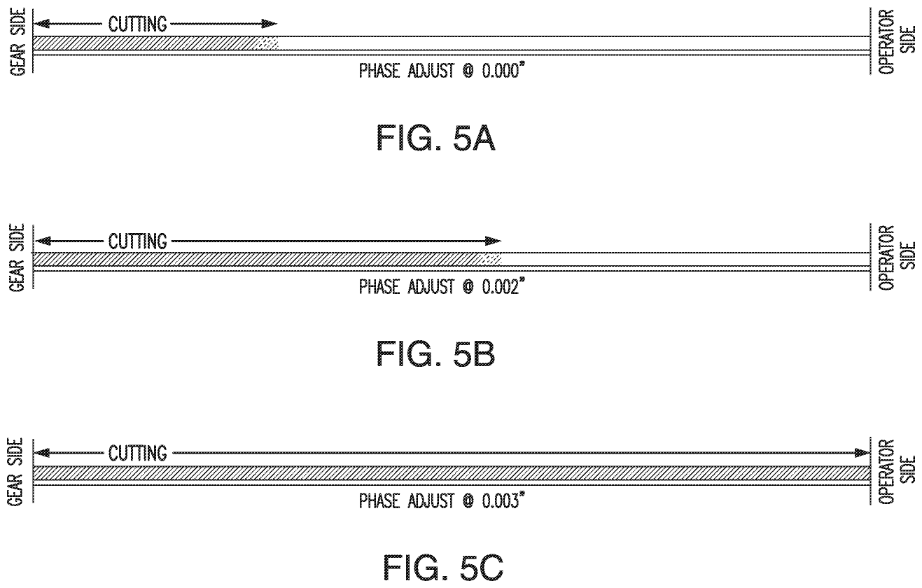

An Example is shown in FIGS. 5A-5C. In FIG. 5A, it can be seen that the gear side is cutting and the operator side is not. After making a phase adjustment of 0.002 inch into the cut direction, cutting is improved and extends further toward the operator side, as shown in FIG. 5B. After making an additional phase adjustment of 0.001 inch into the cut direction, to result in a total adjustment of 0.003 inch, cutting is further improved and extends from the gear side all the way to the operator side, as shown in FIG. 5C.

A total adjustment of 0.003 inch was made to the upper tool so that the tools uniformly cut across the cylinders. This amount indicates the necessary skewing adjustment. Using the axis synchronization system of the present invention, the adjustable wedge screw can be adjusted 0.003 inch into the cut direction on the operator side. To do so, the adjustable wedge screw on the opposite side of the bearing housing can first be adjusted to reduce the spacing it provides, by 0.003 inches. After the skew adjustment is made, the gap can be checked, and the rotational phasing and side-to-side alignment can be double-checked. One side or both sides of the upper tool or lower tool can be used for the skewing adjustment. The skew should not have to be changed by more than 0.015 inch or 0.381 mm on each side. For large skew adjustments, each cylinder can be adjusted by half the required amount to collectively make the adjustment. The object of the skew adjustment is to shift the tools into parallel alignment in order to be able to cut or crease the material properly.

To adjust the position of, for example, the gear side of the upper cylinder, the adjustable wedge screws at the gear side are adjusted. Looking at the upper cylinder from the gear side, if the upper cylinder needs to be adjusted to the left, the left-side adjustable wedge screw is loosened. If the ratio of (1) rotation of the adjustable wedge screw set screw to (2) adjustable wedge screw spread, is 0.001 inch per rotation, then the left-side adjustable wedge screw can be loosened by two full rotations to reduce the spread by 0.002 inch. The resulting 0.002-inch gap would not likely result in a 0.002-inch movement of the upper cylinder to the left but would provide room for a movement of 0.002 inch. Rotation of the right-side adjustable wedge screw, for tightening by two rotations, would result in 0.002-inch movement of the upper cylinder, to the left. Loosening of the adjustable wedge screw on the side toward which movement is desired can be followed by tightening to expand the adjustable wedge screw spread on the opposite side.

FIG. 6A is an end view of a rotary die cutter system comprising an upper rotary tool 601 and a lower rotary tool 651 stacked together. Upper rotary tool 601 includes a rotary cutting cylinder (not shown) that rotates about an axis of rotation 602 and is held by and configured for rotation within an upper bearing housing 612. Similarly, lower rotary tool 651 includes an anvil cylinder (not shown) that rotates about an axis of rotation 622 and is rotatably held at a proximal end by a lower bearing housing 662. Similar bearing housings are provided in a similar stacked configuration at opposite, distal ends of the upper cutting cylinder and the lower anvil cylinder. Upper rotary tool 601 and lower rotary tool 651 are stacked together in such a manner that cutting blades or lands on the upper cutting cylinder cooperate with cutting blades or lands, or other counter features, on the lower anvil cylinder such that the upper cutting cylinder and the lower anvil cylinder work together to cut and form material passing through a nip formed between the cylinders. One or more shims 640 can be placed between upper rotary tool 601 and lower rotary tool 651 to perfectly space the upper cutting cylinder and the lower anvil cylinder apart from one another. A pressure block 634 is pressed down by a pressure screw (not shown) to maintain upper rotary tool 601 in contact with lower rotary tool 651.

Although the upper cutting cylinder cannot be seen in FIG. 6A, an end cap 630 for upper bearing housing 612 is shown nested in a pilot recess 632. Similarly, an end cap 680 for the lower anvil cylinder (not shown) is shown nested in a pilot recess 682 of lower bearing housing 662.

As can be seen in FIG. 6A, upper bearing housing 612 is mounted to a bow tie plate 620 by eight socket head cap screws 616. Each socket head cap screw can be of any suitable size, for example, from 3/16 inch to 13/16 inch or, for example, ⅜ inch, 7/16 inch, ½ inch, or 9/16 inch. The socket head cap screws can be made of steel, steel alloy, stainless steel, or the like. Hex bolts or other fasteners can instead be used. Bow tie plate 620 is mounted to upper bearing housing 612. A second, i.e., backing bow tie plate (not shown) that is a mirror image of bow tie plate 620, is mounted to the backside of upper bearing housing 612, for example, by eight socket head cap screws. The set of bow tie plate 620 and the backing bow tie plate (not shown), straddle a left side plate 604 and a right-side plate 608. Left side plate 604 presents a vertical surface 614 and right-side plate 608 presents a vertical surface 618. As can be seen, bow tie plate 620 is clamped to side plates 604 and 608 by four set screws 636. The backing bow tie plate can be, but is not necessarily, similarly clamped to side plates 604 and 608 by four set screws. In a similar fashion, lower bearing housing 662 is mounted to a bow tie plate 670 by eight socket head cap screws 616 and a second, backing bow tie plate (not shown), that is a mirror image of bow tie plate 670, is mounted to the backside of lower bearing housing 662, for example, by eight socket head cap screws. The set of bow tie plate 670 and the mirror image backing bow tie plate (not shown), straddle left side plate 604 and right side plate 608. Like bow tie plate 620, bow tie plate 670 is clamped to side plates 604 and 608 by four set screws 636. The backing bow tie plate that backs bow tie plate 670 can be, but is not necessarily, similarly clamped to side plates 604 and 608 by four set screws.

Set screws 636 can bear against flat front vertical surfaces of side plates 604 and 608. According to various embodiments, set screws 636 can be omitted such that bow tie plates 620 and 670 are not clamped to side plates 604 and 608 using set screws, in which case pressure block 634 is primarily what is used to force upper rotary tool 601 into contact with lower rotary tool 651. In some cases, the upper and lower rotary tools can be held between side plates 604 and 608 solely by adjustable wedge screws according to the present invention.

As shown in FIG. 6A, bow tie plates 620 and 670 are clamped to side plates 604 and 608 and can be horizontally adjusted between side plates 604 and 608 by eight adjustable wedge screws 601, 603, 605, 607, 609, 611, 613, and 615. The adjustable wedge screws can be, for example, as shown in FIGS. 1A-3G.

As mentioned above, bow tie plate 620 is bolted to upper bearing housing 612 by eight socket head cap screws 616. In this regard, it can be seen that upper bearing housing 612 flares-out at its left and right sides as shown by the phantom lines. Similarly, lower bearing housing 622 flares-out at its left and right sides as also shown by phantom lines. The phantom lines are shown because upper bearing housing 612 is behind bow tie plate 620 and lower bearing housing 662 is behind bow tie plate 670, in the view shown.

FIG. 6A also shows a grease fitting 628 for lubricating upper rotary tool 601 and, more particularly, upper bearing housing 612. Similarly, a grease fitting 678 is provided for lubricating lower bearing housing 662 of lower rotary tool 651.

As shown in FIG. 6A, upper rotary tool 601 is held between side plates 604 and 608, and can be adjusted for skew, by four adjustable wedge screws 601, 603, 605, and 607. Each adjustable wedge screw can be as described herein. Greater details of each adjustable wedge screw can be seen in FIG. 6B. FIG. 6B is an enlarged view of section 6B shown in FIG. 6A. With reference to FIG. 6B, adjustable wedge screw 601 is mounted by a bracket 60 to upper bearing housing 612. A washer 68 and hex bolt 66 are used to mount bracket 60 to upper bearing housing 612. Upper bearing housing 612 has a tapped, threaded hole for receiving hex bolt 66. As can be seen, adjustable wedge screw 601 is urged against vertical side wall 614 of side plate 604. Similar to the adjustable wedge screw depicted in FIGS. 1A-3G, adjustable wedge screw 601 comprises a spilt wedge 20, a first block 40, a second block 30, bracket 60, and a threaded adjustment screw 50. A washer 52 is provided to space the head of threaded adjustment screw 50 from the facing surface of bracket 60. Tightening threaded adjustment screw 50 pulls spilt wedge 20 closer to the head of threaded adjustment screw 50 and spreads first block 40 and second block 30 further apart from each other. Thus, the effect of tightening threaded adjustment screw 50 is the movement of upper bearing housing 612, and the upper cutting cylinder that it supports, to the right. Loosening threaded adjustment screw 50 forces spilt wedge 20 away from the head of the threaded adjustment screw 50 such that first block 40 and second block 30 come closer together by virtue of a biasing device such as a spring steel internal retaining ring as described and shown in connection with FIGS. 1A-1G. Moving first block 40 and second block 30 closer together enables upper bearing housing 612 to move to the left, particularly, when adjustable wedge screw 603 (FIG. 6A) is correspondingly tightened. Tightening or loosening each of the eight adjustable wedge screws shown in FIG. 6A can be used to adjust skew of the upper cutting cylinder and the lower anvil cylinder of the rotary die. A similar set of upper and lower bearing housings and adjustable wedge screws can be provided at the opposite ends of the upper cutting cylinder and the lower anvil cylinder.

Although not shown, one, two, or more adjustable wedge screws can also be provided between an upper rotary tool and a lower rotary tool to adjust the gap between the tools. In this regard, while the adjustable wedge screws shown and described herein might not fit in a space between, for example, upper rotary tool 601 and lower rotary tool 651 shown in FIG. 6A, one or more brackets can be used. For example, two L-shaped brackets, one mounted to the end of each rotary tool, can be provided such that an adjustable wedge screw as shown and described herein can be positioned between extending arms of the two brackets. A similar set of brackets can be used to house there between an adjustable wedge screw at the opposite ends of the upper and lower rotary tools. As such, one or more adjustable wedge screws as shown and described herein can be used to adjust the gap between upper and lower rotary tools without the need to position the one or more adjustable wedge screws physically between the rotary tools.

The entire contents of all references cited in this disclosure are incorporated herein in their entireties, by reference. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether such a range is separately disclosed. Where a range of numerical values is recited herein, unless otherwise stated, the range is intended to include the endpoints thereof, and all integers and fractions within the range. It is not intended that the scope of the invention be limited to the specific values recited when defining a range.

All patents, patent applications, and publications mentioned herein are incorporated herein in their entireties, by reference, unless indicated otherwise.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

What is claimed is:

1. An adjustable wedge apparatus comprising a split wedge, a first block, a second block, a threaded adjustment screw, and an expandable and contractable biasing device, wherein:
the split wedge is configured to be sandwiched between the first block and the second block;
the first block and the second block are configured to be held together, with the split wedge between, by the expandable and contractable biasing device;
the split wedge has a blunt end, a narrow end, a recess, a through-hole, and a pair of through-slots, the recess having an opening at the narrow end, extending toward the blunt end, having a recess bottom, and dividing the narrow end into two tines, the through-hole extending from the blunt end to the bottom of the recess and having an internal thread, the pair of through-slots at least partially straddling the recess and respectively extending along the tines;
the threaded adjustment screw has an external thread that is complementary to the internal thread of the through-hole;
each of the first block and the second block has a pair of projections configured to align respectively with the pair of through-slots, for catching the biasing device; and
each through-slot of the pair of through-slots, and the biasing device, are configured such that the biasing device can pass through either through-slot and catch one of the projections of the first block and one of the projections of the second block.

2. The adjustable wedge apparatus of claim 1, assembled together, wherein the split wedge is sandwiched between the first block and the second block, the biasing device is caught on a first projection of the pair of projections of the first block and caught on a first projection of the pair of projections of the second block, the biasing device passes through a first through-slot of the pair of through-slots and biases the first block and the second block toward one another, and the threaded adjustment screw bears against the first block and the second block, extends through the recess, and is threaded into the through-hole.

3. The assembled adjustable wedge apparatus of claim 2, further including a washer, wherein the threaded adjustment screw has a head, and the washer is positioned adjacent the head and bears on both the first block and the second block.

4. The assembled adjustable wedge apparatus of claim 2, wherein the projections of the first block have respective distal ends and the distal ends are separated in a height direction by a first distance, the through-slots of the spilt wedge are separated by a maximum spacing, and the first distance is greater than the maximum spacing.

5. The assembled adjustable wedge apparatus of claim 4, wherein the biasing device comprises a flat, metal, split, planar ring that can expand and contract within a plane but is rigid with respect to deforming out of the plane.

6. The assembled adjustable wedge apparatus of claim 5, wherein the biasing device comprises a spring steel material.

7. The adjustable wedge apparatus of claim 1, further comprising a mounting bracket in contact with or integral with at least one of the first block and the second block, the mounting bracket having a through-hole formed therethrough and through which a fastener can partially pass to mount the mounting bracket to a surface.

8. The adjustable wedge apparatus of claim 7, wherein the mounting bracket is integral with the first block.

9. The adjustable wedge apparatus of claim 7, wherein the mounting bracket is a separate component, not integral with either the first block or the second block.

10. The adjustable wedge apparatus of claim 1, wherein the biasing device comprises a pair of biasing devices.

11. The adjustable wedge apparatus of claim 10, wherein the biasing device comprises a pair of retaining rings.

12. The adjustable wedge apparatus of claim 1, wherein the biasing device comprises an internal retaining ring having internally protruding inner ring features on which the projections of the first block and the second block can catch.

13. The adjustable wedge apparatus of claim 1, wherein the pair of projections on the first block comprises opposite ends of a slotted spring pin extending through a first block through-hole, the first block through-hole being formed through the first block in a height direction.

14. The adjustable wedge apparatus of claim 13, wherein the pair of projections on the second block comprises opposite ends of a second slotted spring pin extending through a second block through-hole, the second block through-hole being formed through the second block in a height direction.

15. The adjustable wedge apparatus of claim 13, wherein the first block has a first top surface, an opposite first bottom surface, and a first inner side surface configured to contact the spilt wedge, each of the first top surface and the first bottom surface has a block recess formed therein, and the pair of projections of the first block protrude from the first top surface block recess and from the first bottom surface block recess.

16. The adjustable wedge apparatus of claim 15, wherein the second block has a second top surface, an opposite second bottom surface, and a second inner side surface configured to contact the spilt wedge, each of the second top surface and the second bottom surface has a block recess formed therein, and the pair of projections of the second block protrude from the second top surface block recess and from the second bottom surface block recess.

17. An axle alignment system comprising an axle configured for rotation around an axis of rotation, and the assembled adjustable wedge apparatus of claim 2, wherein the assembled adjustable wedge apparatus is positioned in contact with the axle or in contact with an axle bearing unit that holds an end of the axle, such that adjusting the assembled adjustable wedge apparatus by turning the threaded adjustment screw changes a position of the axis of rotation.

18. A rotary die system comprising the axle adjustment system of claim 17.

19. A method of adjusting an axis of rotation of an axle, the method comprising:
providing the axle alignment system of claim 17; and
turning the threaded adjustment screw to change a position of the axis of rotation.
